(19) United States
(12) Patent Application Publication
(10) Pub. No.: US 2012/0327122 A1
(43) Pub. Date: Dec. 27, 2012

(54) MOBILE TERMINAL DEVICE, STORAGE MEDIUM AND DISPLAY CONTROL METHOD OF MOBILE TERMINAL DEVICE

(75) Inventor: Hitoshi IMAMURA, Osaka (JP)

(73) Assignee: KYOCERA CORPORATION, Kyoto (JP)

(21) Appl. No.: 13/533,568

(22) Filed: Jun. 26, 2012

(30) Foreign Application Priority Data
Jun. 27, 2011 (JP) 2011-142375

(51) Int. Cl. G06F 3/041; G09G 5/34

(52) U.S. Cl. 345/649; 345/173

(57) ABSTRACT

A mobile terminal device includes a display section having a display surface, a first detecting section which detects a touch input to the display surface, a second detecting section which detects a touch input to a surface facing a back side of the display surface, and a screen controlling section which executes a control to change a screen displayed on the display section based on a combination of the touch input detected by the first detecting section and the touch input detected by the second detecting section.

### RELATED APPLICATIONS

This application claims priority under 35 U.S.C. Section 119 of Japanese Patent Application No.2011-142375 filed Jun. 27, 2011, entitled “MOBILE TERMINAL DEVICE, PROGRAM AND DISPLAY CONTROL METHOD”. The disclosure of the above application is incorporated herein by reference.

### BACKGROUND OF THE INVENTION

1. Field of the Invention

The present invention relates to a mobile terminal device such as a mobile phone, a PDA (Personal Digital Assistant), a tablet PC, an e-book and so forth, a storage medium which retains a computer program suitable for use in the mobile terminal device and a display control method of the mobile terminal device.

2. Disclosure of Related Art

Conventionally, in a mobile terminal device with a touch panel, by performing an input to a display surface, various operations are performed. For example, a screen displayed on the display surface changes based on a running application program (hereinafter, referred to as an “application”) according to the input to the display surface.

A construction performing the input to the display surface enables direct input to an image displayed, thereby outperforming in operability. However, in the construction capable of performing the input to only one display surface as the above, variations of input operation is limited. Therefore, there could be a case that is difficult to realize an easy and intuitive input operation.

### SUMMARY OF THE INVENTION

A first aspect of the present invention relates to a mobile terminal device. The mobile terminal device according to the present aspect includes a display section having a display surface, a first detecting section which detects a touch input to the display surface, a second detecting section which detects a touch input to a surface facing a back side of the display surface, and a screen controlling section which executes a control to change a screen displayed on the display section based on a combination of the touch input detected by the first detecting section and the touch input detected by the second detecting section.

A second aspect of the present invention relates to a storage medium which retains a computer program applied to a mobile terminal device. The mobile terminal device includes a display section having a display surface, a first detecting section which detects a touch input to the display surface, and a second detecting section which detects a touch input to a surface facing a back side of the display surface. The computer program provides a computer of the mobile terminal device with a function for changing the screen displayed on the display section based on a combination of the touch input detected by the first detecting section and the touch input detected by the second detecting section.

A third aspect of the present invention relates to a display control method of a mobile terminal device comprising a display section having a display surface, a first detecting section which detects a touch input to the display surface, a second detecting section which detects a touch input to a surface facing a back to the display surface. The display control method relating to the present aspect includes steps of: determining the touch inputs to the display surface and the surface facing a back side of the display surface based on outputs of the first detecting section and the second detecting section; and changing the screen displayed on the display section based on a combination of the touch input to the display surface and the touch input to the surface facing a back side of the display surface.

### BRIEF DESCRIPTION OF THE DRAWINGS

The above and other objects and new features of the present invention will be cleared more completely by reading the following description of preferred embodiments with reference to the following accompanying drawings.

FIGS. 1A to 1C are diagrams illustrating an appearance constitution of a mobile phone according to an embodiment;

FIGS. 2A and 2B are diagrams illustrating an input state by a both faces touch according to the embodiment;

FIG. 3 is a block diagram illustrating an entire constitution of the mobile phone according to the embodiment;

FIG. 4 is a flowchart for describing a processing procedure according to the embodiment;

FIGS. 5A to 5H are diagrams illustrating screen transition examples in a process according to an example 1;

FIGS. 6A and 6B are diagrams illustrating the screen transition examples in a process according to an example 2;

FIGS. 7A to 7G are diagrams illustrating the screen transition examples in a process according to an example 3;

FIGS. 8A to 8F are diagrams for describing a pinch and rub operation according to the example 3;

FIG. 9 is a flowchart for describing a processing procedure according to the example 3;

FIGS. 10A and 10B are diagrams illustrating the screen transition examples in a process according to an example 4;

FIG. 11 is a flowchart for describing the processing procedure according to the example 4;

FIGS. 12A to 12C are diagrams illustrating the screen transition examples in a process according to a modification 1;

FIGS. 13A and 13B are diagrams illustrating the screen transition examples in a process according to the modification 2;

FIGS. 14A and 14B are diagrams illustrating the screen display examples in a process according to the other modification;

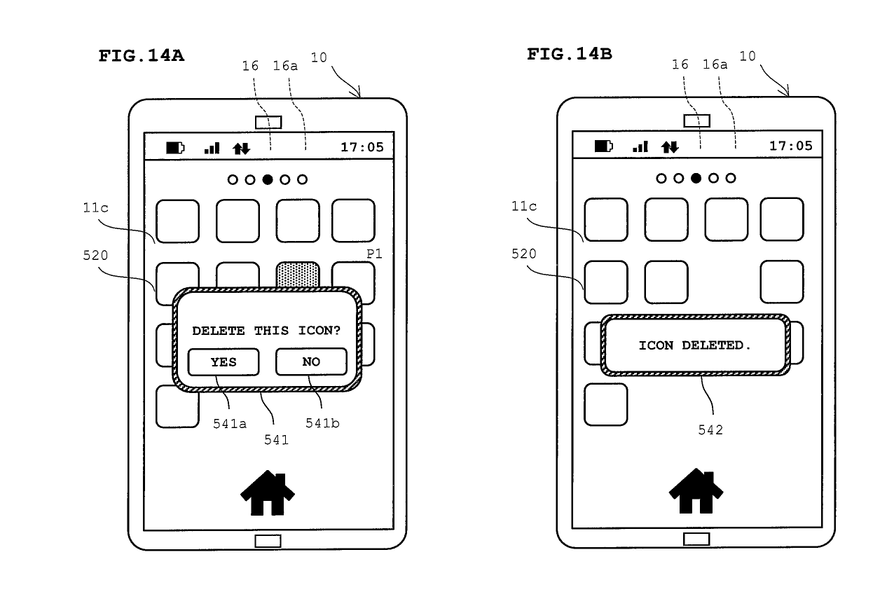

FIGS. 15A to 15O are diagrams illustrating the screen transition examples in a process according to the other modification;

FIGS. 16A and 16B are diagrams illustrating the screen transition examples in a process according to the other modification;

FIGS. 17A and 17B are diagrams illustrating the screen transition examples in a process according to the other modification;

FIGS. 18A to 18C are diagrams illustrating the screen transition examples in a process according to the other modification;

FIGS. 19A and 19B are diagrams illustrating the screen transition examples in a process according to the other modification; and

FIGS. 20A and 20B are diagrams illustrating the screen transition examples in a process according to the other modification.

The drawings are, however, for the description, and do not limit the scope of the present invention.

### DESCRIPTION OF PREFERRED EMBODIMENTS

Preferred embodiments of the present invention are described below with reference to the drawings.

In the present embodiment, display 11 corresponds to a “display section” recited in the claims. Touch sensor 12 corresponds to a “first detecting section” recited in the claims. Touch sensor 16 corresponds to a “second detecting section” recited in the claims. Input surface 16a corresponds to a “surface facing a back side of the display surface” recited in the claims. CPU 100 corresponds to a “screen control section” recited in the claims. A description of corresponding above claims and the present embodiments is simply an example, and it does not limit the claims to the present embodiments.

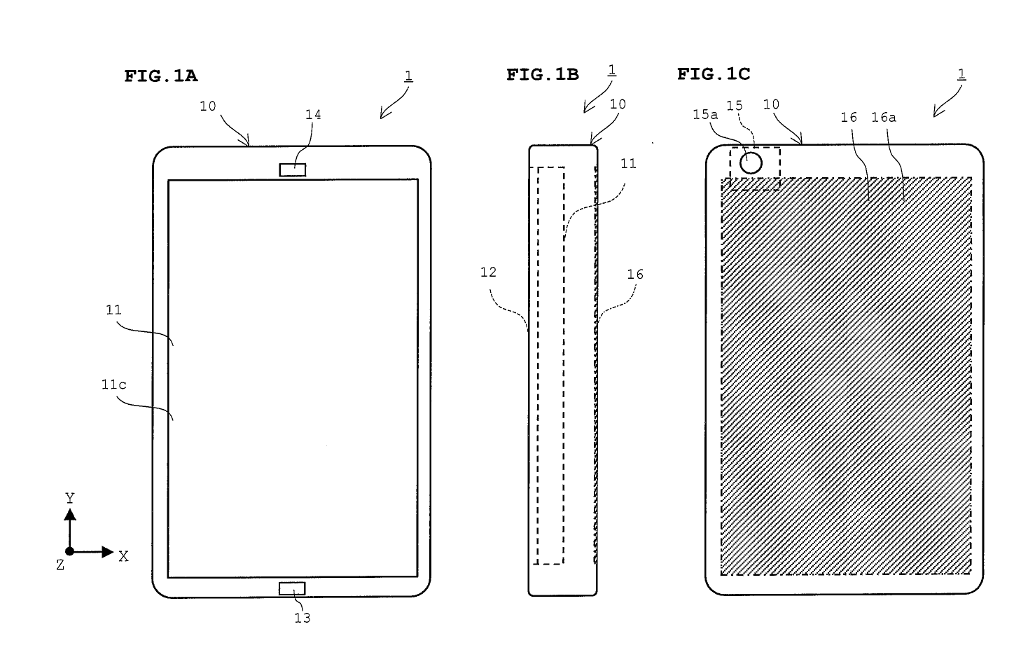

FIGS. 1A to 1C are diagrams illustrating an appearance constitution of a mobile phone 1. FIGS. 1A, 1B and 1C are front view, side view and back view, respectively.

The mobile phone 1 includes cabinet 10. A touch panel is arranged on the front surface of the cabinet 10. The touch panel includes display 11 for displaying a screen and touch sensor 12 overlapped on the display 11.

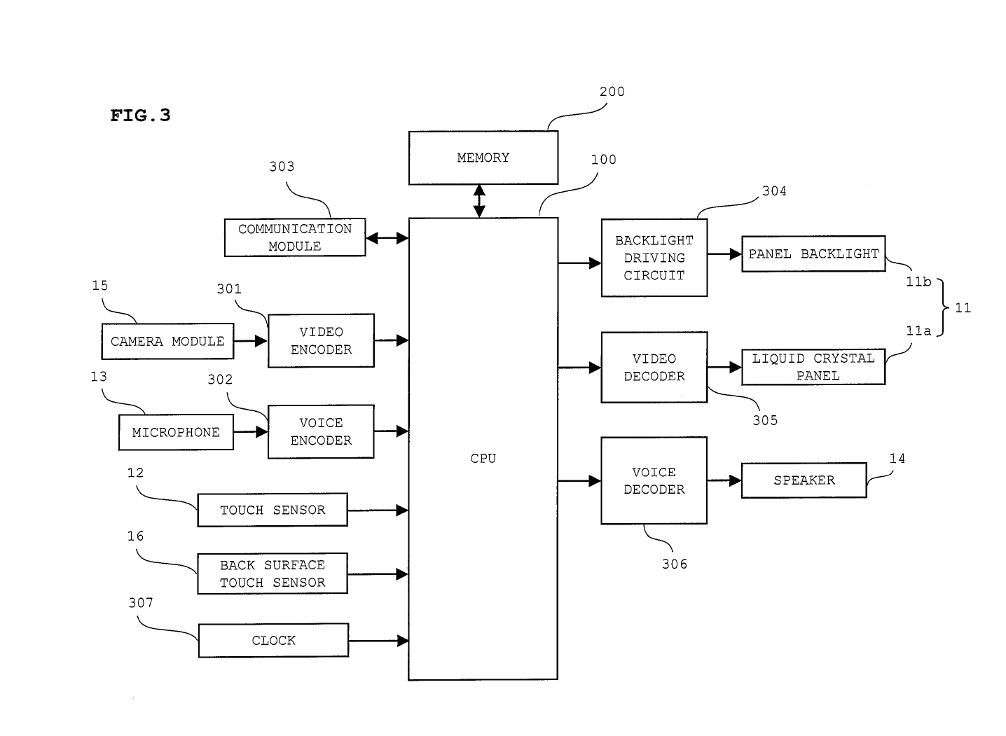

The display 11 is constructed with a liquid crystal panel 11a and a panel backlight 11b which illuminates the liquid crystal panel 11a (see FIG. 3). The liquid crystal panel 11a includes a display surface 11c to display the screen, and the display surface 11c is exposed to outside. Touch sensor 12 is disposed on the display surface 11c. Another display element such as an organic EL display, LED display, etc., maybe used instead of the display 11.

The touch sensor 12 is formed into a shape of a transparent sheet. A user can see the display surface 11c through the touch sensor 12. In the present embodiment, the touch sensor 12 is a capacitance touch sensor. The touch sensor 12 detects a position where the user touched on the display surface 11 (hereinafter, referred to as a “first input position”) from changes in the capacitance, and outputs a position signal according to the first input position to a CPU 100 described later.

A surface which faces the back side of the display surface 11c, that is the back surface of cabinet 10 is provided with a touch sensor 16 (see shaded areas of FIGS. 1B and 1C). The size of the touch sensor 16 is almost the same with the display surface 11c, and the touch sensor 16 is almost exactly overlapping on the display surface 11c when seen from the front side of the cabinet 10. As the same with the touch sensor 12, the touch sensor 16 is a capacitance touch sensor formed into a shape of a transparent sheet. The touch sensor 16 detects a position where the user touched on the touch sensor 16 (hereinafter, referred to as a “second input position”) from changes in the capacitance, and outputs a position signal according to the second input position to the CPU 100 described later. Hereinafter, the surface of the touch sensor 16 which is exposed outside is called “input surface 16a.”

The touch sensor 12 and 16 are not limited to the capacitance touch sensor, and thus may be other touch sensors, such as an ultrasonic touch sensor, a pressure-sensitive touch sensor, a resistive touch sensor, or a photo-detective touch sensor.

Microphone 13 and speaker 14 are arranged on a front side of the cabinet 10. A user can hold a conversation by catching a voice from the speaker 14 by the user's ears and by talking to the microphone 13.

Lens window 15a of camera module 15 is arranged on a back side of the cabinet 10. An image of a subject is captured through the lens window 15a into the camera module 15.

In the present modification, a “touch” means, for example, touching the display surface 11c and/or input surface 16a with a finger (or other contact members, and so forth) by the user. The “touch” includes operations of following slide, tap, flick, and so on. “Slide” means an operation for continuously moving a finger on the display surface 11c and/or input surface 16a performed by the user. “Tap” means an operation for knocking on the display surface 11c and/or the input surface 16a with fingers lightly by the user, and an operation for touching a certain place on the display surface 11c and/or the input surface 16a with a finger and releasing the finger in a predetermined time. “Flick” means an operation for releasing the finger from the display surface 11c and/or the input surface 16a quickly in a flicking manner performed by the user, and while touching the display surface 11c and/or the input surface 16a with the finger, within a predetermined time period, the finger is moved for more than predetermined distance, then released.

“Both faces touch” is an operation of touching the both display surface 11c and the input surface 16a. That is, the operation of the both faces touch is a combination of the touch operations to each of the display surface 11c and the input surface 16a.

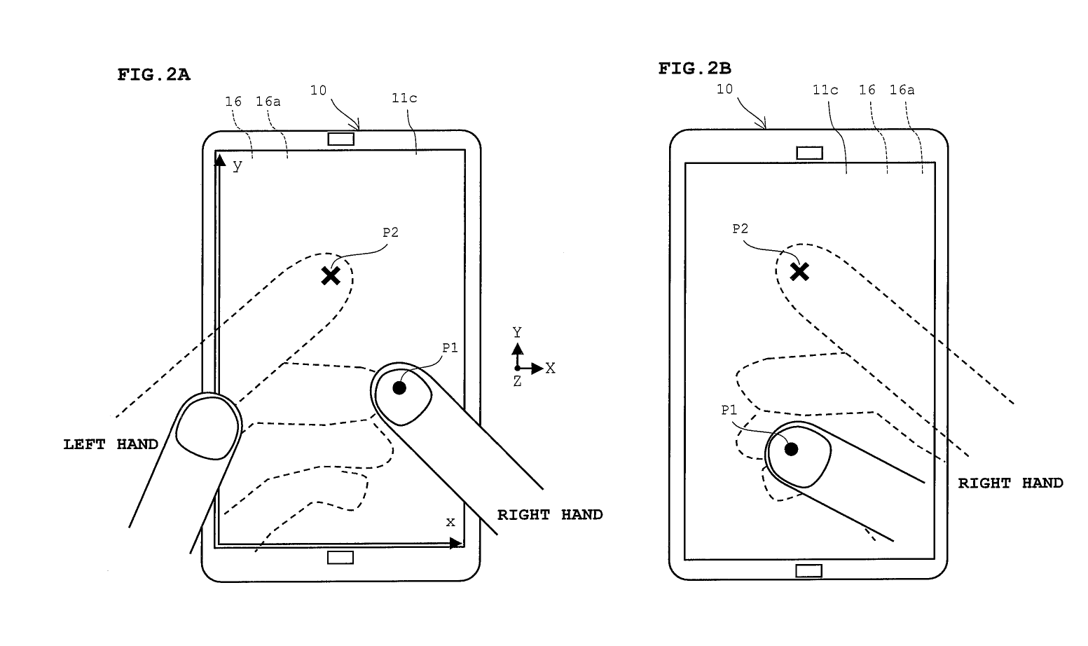

FIGS. 2A and 2B are diagrams illustrating while a both faces touch operation is performed. In FIGS. 2A and 2B, the first input position P1 is marked with a filled circle and the second input position P2 is marked with “X”-shaped sign (and so on).

FIG. 2A is a diagram showing a user is holding the mobile phone 1 in his/her left hand, left index finger touches the input surface 16a, and the right index finger touches the display surface 11c. Also, FIG. 2B shows a state that a user holds the mobile phone in his/her right hand, and the index finger of the right hand touches the input surface 16a and the thumb of the right hand touches the display surface 11c.

FIG. 2A, for the sake of convenience, illustrates an x-y coordinate axis with its origin at the bottom left corner of the display surface 11c. The input surface 16a is set with an x-y coordinate axis with its origin at the bottom left corner of the input surface 16a seen from the display surface 11c side. First input position P1 and second input position P2 are obtained respectively by the CPU 100 as coordinate points on the x-y coordinate axis of the display surface 11c and the x-y coordinate axis of the input surface 16a. The origin of x-y coordinate axis set for the display surface 11c and the origin of x-y coordinate axis of the input surface 16a are overlapped to each other when seen from the display surface 11c side.

FIG. 3 is a block diagram illustrating an entire constitution of the mobile phone 1.

The mobile phone 1 of the present embodiment provides CPU 100, memory 200, video encoder 301, voice encoder 302, communication module 303, backlight driving circuit 304, video decoder 305, voice decoder 306 and clock 307, other than the above mentioned each component.

The camera module 15 includes a photographing section that has an image pickup device such as a CCD, and photographs an image. The camera module 15 digitalizes an imaging signal output from the image pickup device, and makes various corrections such as a gamma correction on the imaging signal so as to output the signal to the video encoder 301. The video encoder 301 executes an encoding process on the imaging signal from the camera module 15 so as to output the signal to the CPU 100.

The microphone 13 converts the collected voices into a voice signal so as to output the signal to the voice encoder 302. The voice encoder 302 converts the analog voice signal from the microphone 13 into a digital voice signal, and executes an encoding process on the digital voice signal so as to output the signal to the CPU 100.

The communication module 303 converts information from the CPU 100 into a radio signal, and transmits the signal to a base station. Further, the communication module 303 converts the radio signal received into information so as to output the information to the CPU 100.

Backlight driving circuit 304 supplies a driving signal according to a control signal from the CPU 100 to the panel backlight 11b. The panel backlight 11b turns on by means of a driving signal from the backlight driving circuit 304, and illuminates the liquid crystal panel 11a.

The video decoder 305 converts the video signal from the CPU 100 into an analog or digital video signal that can be displayed on the liquid crystal panel 11a, and outputs the converted image signal to the liquid crystal panel 11a. The liquid crystal panel 11a displays a screen according to the input video signal on the display surface 11c.

The voice decoder 306 executes a decoding process on the voice signal from the CPU 100 and sound signals of various alarm sounds such as a ringtone or an alarm sound, and converts the signals into analog voice signals and analog sound signals so as to output them to the speaker 14. The speaker 14 outputs a voice and an alarm sound based on a voice signal and a sound signal from the voice decoder 306.

The clock 307 counts time, and outputs a signal according to the counted time to the CPU 100.

Memory 200 includes ROM and RAM. The memory 200 stores control programs for giving control functions to the CPU 100.

The memory 200 is also used as a working memory of the CPU 100. That is, the memory 200 stores data temporary used or generated when each application program for phone call, e-mail usage, image browsing, and image processing, etc., is executed. For example, the memory 200 stores information related to inputs (touch inputs) to the display surface 11c and the input surface 16a, data for displaying a screen on the display surface 11c, etc.

The CPU 100 operates microphone 13, communication module 303, panel backlight 11b, liquid crystal panel 11a and speaker 14 according to a controlling program executed based on input signals from touch sensor 12 and 16, video encoder 301, voice encoder 302, communication module 303 and clock 307. With this operation, a wide variety of applications is executed.

The CPU 100 obtains data of a predetermined image stored in the memory 200 based on an execution of the control program or the application. Or, the CPU 100 generates the data of predetermined image based on the execution of the control program or the application. The CPU 100 generates a signal including data of a predetermined screen which is to be displayed on the display surface 11c from the image data obtained or generated, and outputs the generated signal to the video decoder 305.

The CPU 100 holds the first input position P1 and the second input position P2 obtained from the touch sensors 12 and 16 as data shown by the same coordinate system seen from the front side of the mobile phone 1. For example, when almost the same positions on the display surface 11c and the input surface 16a seen from the front of the mobile phone 1 are touched respectively, the coordinates of the first input position P1 and the second input position P2 obtained by this action would be almost the same.

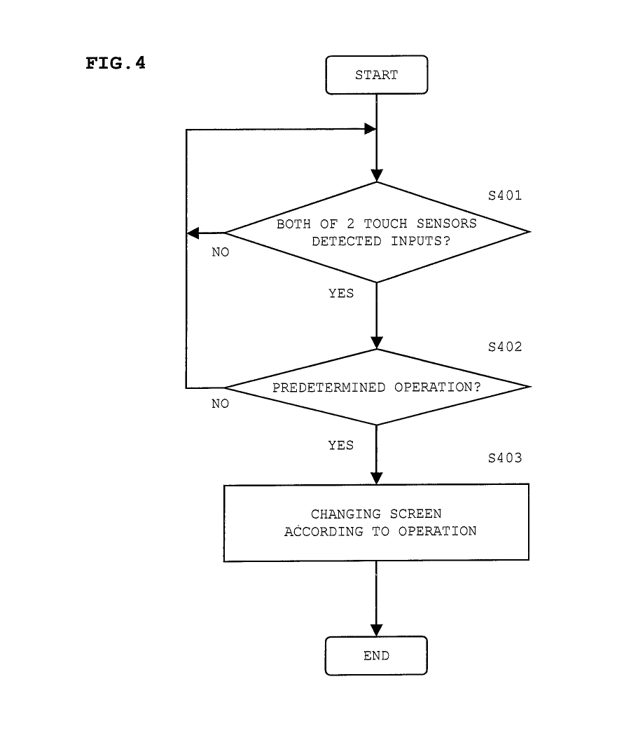

FIG. 4 is a flowchart for describing a processing procedure according to the embodiment.

While a predetermined application is executed, touch sensor 12 and 16 detect inputs toward the display surface 11c and input surface 16a, respectively (S401: YES), the CPU 100 determines whether these inputs correspond to the predetermined operation or not (S402). Then, when the inputs toward the display surface 11c and the input surface 16a correspond to the predetermined operation (S402: YES), the CPU 100 changes the displaying screen according to this operation (S403).

The determination in S402 and the change of screen in S403 are different for each application. Below, concrete examples of determination in S402 and change of screen in S403 are explained.

### Example 1

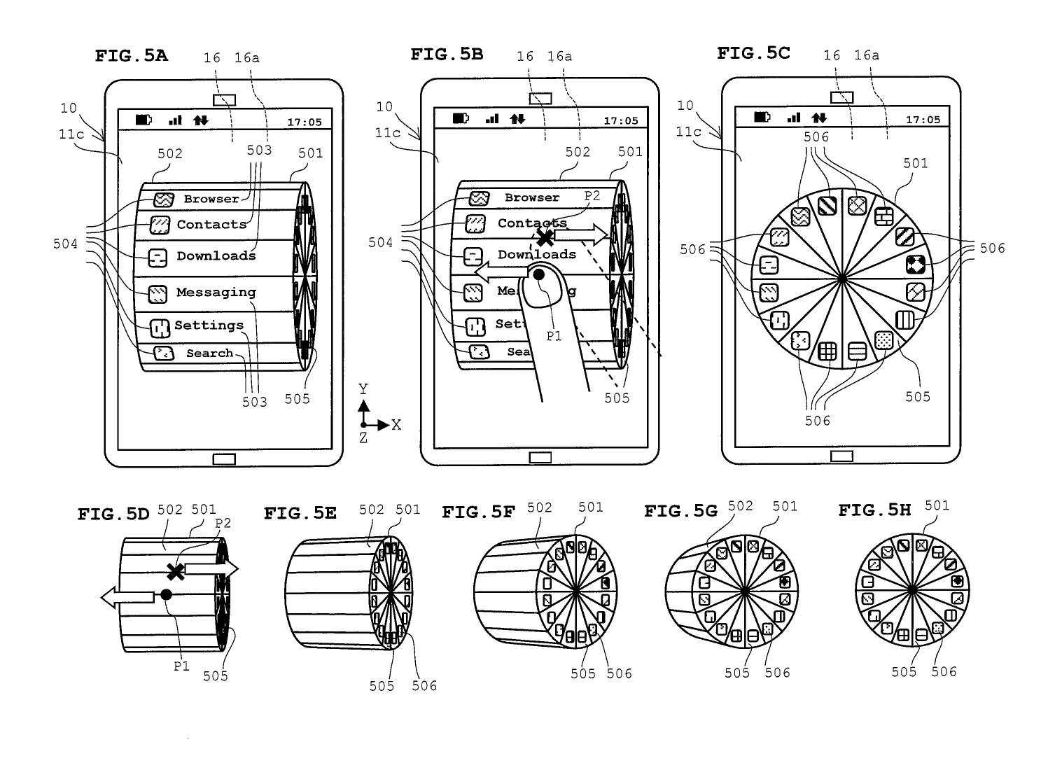

FIGS. 5A, 5B and 5C are diagrams illustrating screen transition examples including a list image. An application shown in this example performs a function of web search, etc., by an operation to the list images.

The list images are images that predetermined options are listed. The list images are sorted out in a plurality of areas, and options to perform predetermined functions are assigned to each area. Among the options posted as list images, one option is selected (for example, tapping the area of an item showing the function), the CPU 100 executes a process corresponding to the option.

The screen shown in FIG. 5A includes an image of three dimensional cylindrical object 501 whose center axis faces the side direction (the X-axis direction). List image 502 is arranged around circumferential surface of the three dimensional object 501. Also, in FIG. 5A, on the end surface of right side of the three dimensional object 501, a list image 505 (see FIG. 5C), which is different from another list image 502, is arranged.

Referring to FIG. 5A, the list image 502 is divided evenly into 16 areas in a circumferential direction. In each area of the list image 502, text 503 which specifies the function assigned to the area and image 504 which depicts the function simply are displayed. For example, in FIG. 5A, lowest area is assigned with a function of web search. For this area, text 503 of “Search” and magnifying glass like image 504 symbolizing the web search are arranged. A user can easily identify the function assigned for each area by checking the text 503 or image 504 displayed on each area.

In FIG. 5, for the sake of convenience, there are no concrete images illustrated on the image 504, however, in reality, each image 504 depicts the corresponding function simply and respectively as the above image showing the magnifying glass, etc.

In FIG. 5A, among 16 kinds of functions, half the number, that is, 8 kinds of functions related items are displayed on the display surface 11c. The rest of the items are hidden behind the back side of the three dimensional object 501 and not displayed on the display surface 11c.

The list image 505 arranged on the end surface of the three dimensional object 501 has a disc-like shape. The list image 505 is evenly divided into 16 areas in a circumferential direction. Each area is formed into a shape of a fan, and connected to each area of the list image 502 at arch portions. That is, each area of the list image 505 corresponds to each area of the list image 502 one for one. In each area of the list image 505 is arranged with image 506. The image 506 is the same image with the image 504 arranged in each area of the list image 502 corresponding to each area of the list image 505. Each area of the list image 505 is assigned with the same function with each area of the list image 502 corresponding to each area of the list image 505.

In a display state of FIG. 5A, when a slide or flick operation in a longitudinal direction (Y-axis direction) is performed on the three dimensional object 501, the CPU 100 rotates the three dimensional object 501 by centering the center axis in a direction above operation has been done. As such, since the three dimensional object 501 is rotated, items which were not shown on the display surface 11c on the list image 502, are newly displayed on the display surface 11c.

In a display state of FIG. 5B, after positions on the three dimensional object 501 on the display surface 11c and the input surface 16a are touched respectively, and when a slide operation or flick operation (see an arrow) is done in left direction (X axis negative direction) to the display surface 11c, and at the same time a slide operation or flick operation (see the arrow) is done in right direction (X axis positive direction), the CPU 100 rotates the three dimensional object 501 in the left direction as shown in FIG. 5D-5H on a screen shown on the display surface 11c. Since the three dimensional object 501 is rotated in this way, the list image 505 is displayed on the display surface 11c as shown in FIG. 5C.

In case of slide operation, according to an amount of change of relative distance in the X axis direction between the first input position P1 and the second input position P2, the rotation amount of the three dimensional objective 501 is decided. The three dimensional object 501 displayed on the display surface 11c is more rotated to the left direction as the amount of change of relative distance between the first input position P1 and the second input position is getting bigger. For example, in the state of FIG. 5F, when the movement of the first input position P1 and the second input position P2 is stopped, the rotation of the three dimensional object 501 also stops. In this state, when the touch to the display surface 11c and the input surface 16a is released, the three dimensional object 501 keeps the state of FIG. 5F. After the three dimensional object 501 is reached to the state of FIG. 5C, even if the movement of the first input position P1 and the second input position P2 is continued, the three dimensional object 501 would not be rotated and kept in the state of FIG. 5C.

In case of flick operation, the list image 505 displayed on the display surface 11c is transferred to the states of FIGS. 5E, 5F and 5G from FIG. 5D, and finally reaches to the state of FIG. 5H. That is, in a state of FIG. 5B, an flick operation is performed to the direction of the arrow, the three dimensional object 501 displayed on the display surface 11c is rotated and reaches the state of FIG. 5C.

In a display state of FIG. 5C, when positions on the three dimensional object 501 of the display surface 11c and the input surface 16a are touched respectively, and a slide or flick operation to the other side of the arrow shown in FIG. 5B for each surface 11c and 16a is performed, the CPU 100 rotates the three dimensional object 501 on the screen displayed on the display surface 11c in a right direction in an order of FIG. 5H-5D. By rotating the three dimensional object 501 as the above, the list image 502 is again displayed on the display surface 11c as shown in FIG. 5B.

In the present example, an operation to rotate the three dimensional object 501 from the state of FIG. 5B to FIG. 5C and an operation to rotate the three dimensional object 501 from the state of FIG. 5C to FIG. 5B (slide and flick) correspond to the “predetermined operation” in Step S402 of FIG. 4. The processing to rotate the three dimensional object 501 according to the operation corresponds to the processing of “changing the screen according to the operation” in Step S403 of FIG. 4.

In the above explanation, based on the changes of both input positions (the first input position and the second input position) at the same time, the three dimensional object 501 displayed on the display device 11c is rotated. It is not limited to the above, it can be constructed for the three dimensional object 501 to be rotated based on a move that one of the two input positions is almost stopped, and the other input position is moved by a slide or flick operation. According to the above, switching the screen can be easily done since a variation that being determined to be “predetermined operation” in Step S402 of FIG. 4 increases.

According to the construction of the present example, an image is changed based on a combination of an input to the display surface 11c and an input to the input surface 16a. For this reason, compared to the case where the predetermined operation is only done by an input to the display surface 11c, the variation of operations can be increased. A processing to rotate the three dimensional object 501 is executed by a simple and intuitively understandable operation which is as if two fingers pinch and rotate the three dimensional object 501.

According to a construction of the present example, since the image of the three dimensional object 501 is rotated according to the operation performed, the user can easily recognize that an operation done by the user corresponds to the change on the screen.

Further, according to the present example, the user can obtain the detail of the function assigned to each area in a state of FIG. 5B, and also, by changing the states from FIG. 5B to 5C, all functions selectable can be understood. Thus, the user can choose desired functions smoothly.

In the present example, the list image 505 is arranged on the right side end surface of the three dimensional object 501. However, the same list image with list image 505 may also be arranged on the left side end surface of the three dimensional object 501. In this case, the CPU 100 displays the list image arranged on the left side end surface by rotating the three dimensional object 501 displayed on the display surface 11c in right direction based on a slide or flick operation which is an opposite direction to the slide or flick direction shown in FIG. 5B (see a white arrow).

### Example 2

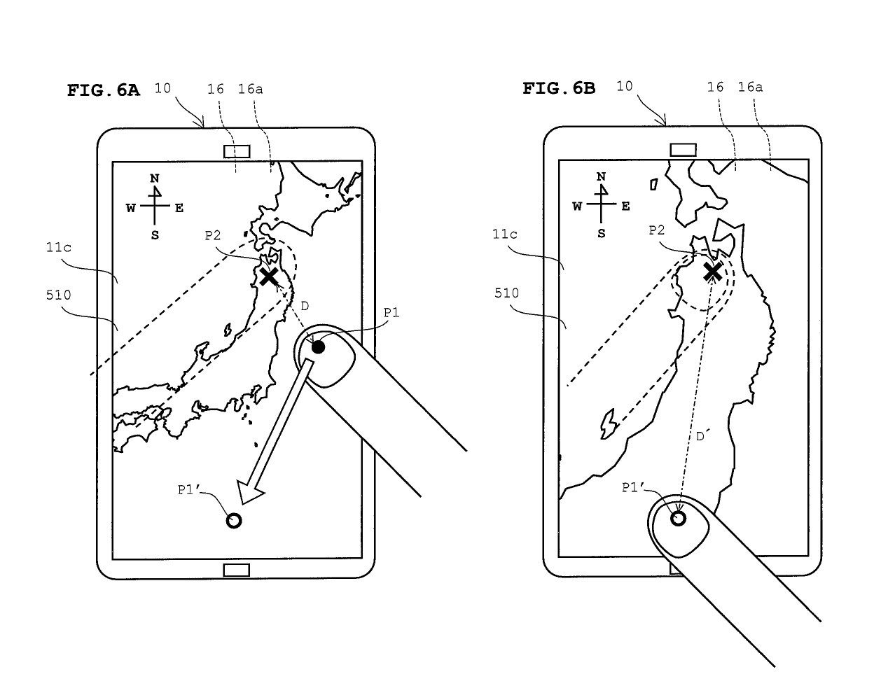

FIGS. 6A and 6B are diagrams illustrating screen transition examples when a process according to the present example is executed. In the present example, while an application to see a map is running, the process of FIG. 4 is executed.

In Step S402 of FIG. 4, the CPU 100 determines whether an operation of sliding on the display surface 11c was performed or not. For example, the CPU 100 determines the Step S402 as YES when the first input position is moved from P1 (filled circle) to P1′ (white circle) after fingers touched both display surface 11c and input surface 16a, as shown with a white arrow of FIG. 6A, according to the slide operation to the display surface 11c.

In Step S403, the CPU 100 obtains a distance between P1-P2 on map image 510 from the first input position P1 and the second input position P2 when fingers touched both display surface 11c and input surface 16a. Then, the CPU 100 enlarges or reduces the map image 510 to make the distance between P1-P2 becomes the same with the distance between P1′-P2.

In concrete, as shown in FIG. 6B, the CPU 100 calculates the distance D between P1-P2 and the distance D′ between P1′-P2 based on the coordinate of the input position P1, P1′ and P2, and calculates a Ratio R=D′/D from the calculated distance D and distance D′. Then, the CPU 100 enlarges or reduces the map image 510 with ratio R by making the second input position P2 as a base point. The map image 510 is enlarged when R>1, and when the R<1, the map image 510 is reduced.

Thus, according to the present example, since the base point is set by a touch to the input surface 16a, on the map image 510 displayed on the display surface 11c, an image near the base point related to enlarging/reducing process would not be covered by fingers, etc. The user can set the ratio R by the operation to the display surface 11c while seeing the map image 510 whose image near the base point is not covered by the fingers, etc. Also, the user can specify the ratio R by a slide to the display surface 11c easily while checking the map and the base point. Thus, the user can enlarge or reduce the map image 510 by a simple and intuitively understandable operation.

It can be constructed to display an image of a predetermined pointer (for example, an arrow or illustrated “X” shaped pointer, etc.) on the second input position P2 overlapping the mage image 510. In this case, correct understanding of the base position is possible, and is convenient. When visibility of the map image 510 is prioritized, it is better not to display the image of the pointer.

### Example 3

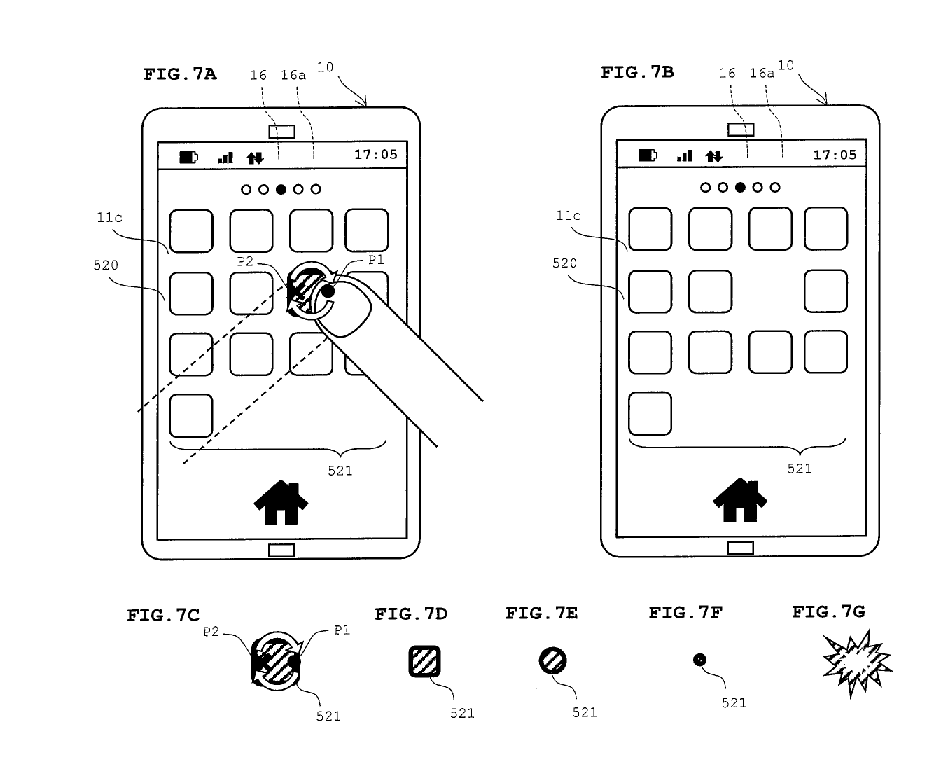

FIGS. 7A-7G are diagrams illustrating the screen transition examples in a process according to the present example.

In FIG. 7A, an application activation screen 520 is displayed on the display surface 11c. The application activation screen 520 includes a plurality (13) of icons (hereinafter, referred to as “icon”) 521 to start the execution of application. While the application activation screen 520 of FIG. 7A is displayed on the display surface 11c, the process of the present example is executed.

In the present example, icons displayed on the application activation screen 520 are deleted by a “pinch and rub operation.”

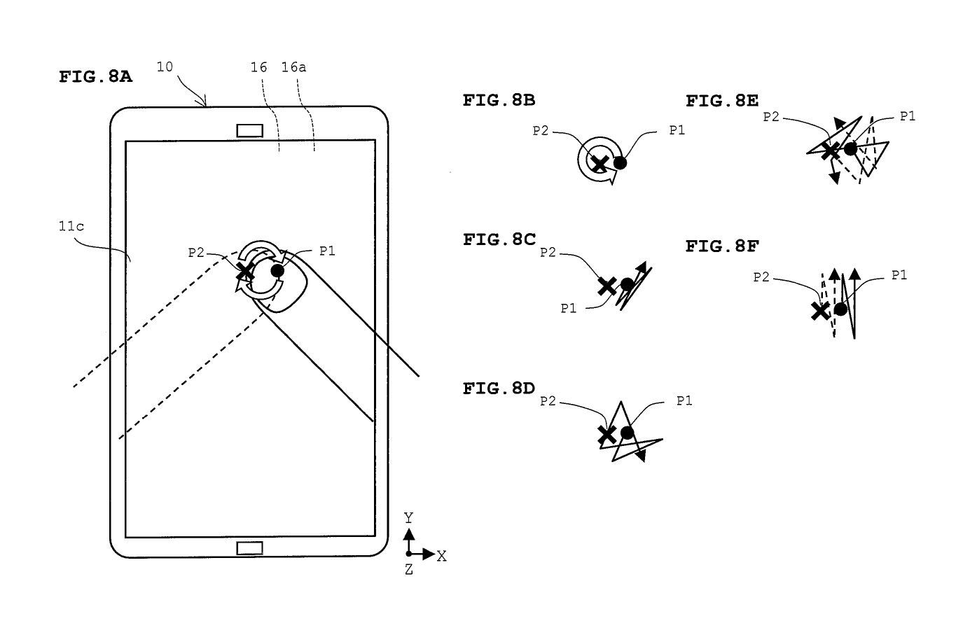

FIGS. 8A-8F are diagrams explaining the pinch and rub operation.

Referring to FIGS. 8A-8F, the “pinch and rub operation” is an operation that both of the display surface 11c and the input surface 16a are touched, a relative distance between the first input position P1 and the second input position P2 is within the predetermined range (for example, several millimeters-a few centimeters), and the first input position P1 or the second input position P2 changes. Here, the relative distance between the first input position P1 and the second input position P2 is a distance between the first input position P1 and the second input position P2 in a direction parallel to the display surface 11c (XY planar direction), and in other words, the distance between the first input position P1 and the second input position P2 seen from the front side of the mobile phone 1.

The CPU 100 determines whether the performed operation is the pinch and rub operation or not based on the obtained first input position P1, second input position P2 and the changes of these input positions.

In FIG. 8A, the pinch and rub operation is illustrated with an example that the input positions P1 and P2 are in a small circulation movement. As shown in FIGS. 8B-8D, the pinch and rub operation includes an operation of one input position (in this case, the first input position P1) moves as if it draws circles (FIG. 8B), an operation of one input position moves back and forth in almost one direction (FIG. 8C) and an operation of one input position moves in random directions (FIG. 8D). Either of the input positions (first input position P1 or second input position P2) may move. Also, a direction of rotation of the input position can be either way (clockwise or counterclockwise). As long as the above determination conditions are fulfilled, it does not matter how the first input position P1 or the second input position P2 moves, that move is the pinch and rub operation. For example, as in FIG. 8E, the first input position P1 and the second input position P2 can move independently of each other, and as in FIG. 8F, the first input position P1 and the second input position P2 can move almost in agreement.

Generally, in a mobile phone with a touch sensor on a display surface, when a screen with icons arranged is displayed on the display surface of the mobile phone, an operation to delete an icon is accepted. For instance, when a user performs an operation of moving an icon to be deleted to a predetermined position (for example, to a trash bin) by sliding the icon, the icon will be deleted. However, if the icons were aligned in a plurality of lines on the screen, it would be difficult to find the above predetermined position to delete the icon.

In contrast, in the present example, icon 521 is deleted by the pinch and rub operation performed on the icon 521. For this reason, the user does not need to look for the predetermined position to delete the icon when deleting the icon.

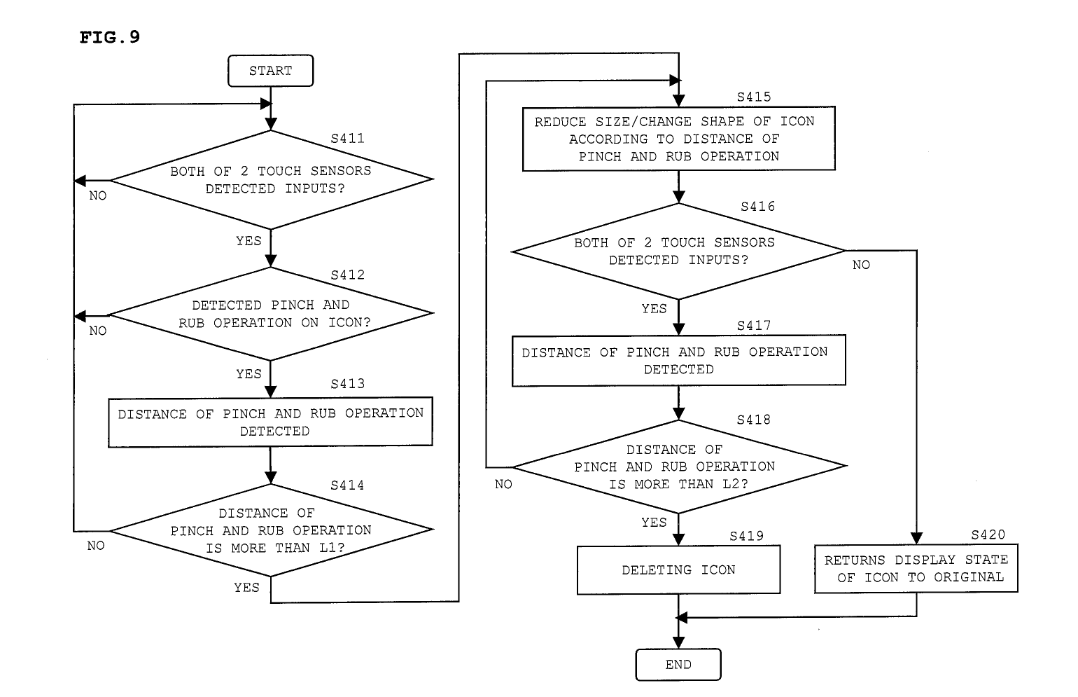

FIG. 9 is a flowchart for describing a processing procedure according to the present example.

As in the above, while application activation screen 520 of FIG. 7A is displayed on the display surface 11c, a processing of FIG. 9 is executed. The processing of Step S411 is the same with the processing of Step S401 of FIG. 4.

The CPU 100 determines whether the input detected at Step S411 is the pinch and rub operation of icon 521 or not (S412). In concrete, the CPU 100 determines whether the position of icon 521 on the display surface 11c and the input surface 16a was touched or not, and whether the above pinch and rub operation was performed or not on the display surface 11c and the input surface 16a.

For example, as shown in FIG. 7A, when the pinch and rub operation is performed for the icon 521 of 2nd line from the top and the second icon from the right, it is determined to be YES at Step S412.

Further, the CPU 100 detects the distance of pinch and rub operation (S413), in a display state of FIG. 7A, when the distance of this pinch and rub operation reaches the predetermined threshold value L1 (for example, several millimeters to a few centimeters) (S414: YES), a process to delete the targeted icon 521 shown in latter part (S415-S420) is executed. When the distance of pinch and rub operation does not reach the threshold value L1, while the pinch and rub operation continues, processing of Steps S411-S414 is executed repeatedly.

When the pinch and rub operation is interrupted on the icon 521 before the distance of pinch and rub operation reaches L1 (S412: NO), the process returns to Step S411.

The “distance of pinch and rub operation” here is the sum of a moving distance (a length of trajectory) of the first input position P1 and a moving distance of the second input position P2 based on the pinch and rub operation from the beginning to the present. As the user continues the pinch and rub operation, the distance of pinch and rub operation increases. When the first input position P1 or the second input position P2 is not detected, the distance of pinch and rub operation will be reset to 0.

For example, when a user paused while touching the fingers on the display surface 11c and the input surface 16a in the middle of the pinch and rub operation, an increase of the distance of pinch and rub operation stops. In this case, the distance of the pinch and rub operation would not be reset to 0, and when the pinch and rub operation is later restarted, the distance of the pinch and rub operation increases again.

In Step S415 of FIG. 9, the CPU 100 highlights the icon 521 which is a target of the pinch and rub operation, and depends on the pinch and rub operation distance, the CPU 100 changes the size and the shape of the icon 521 into smaller and rounder gradually as shown in FIGS. 7C-7F. Even after that, when the first input position P1 and the second input position P2 are detected (S416: YES), the CPU 100 continues to detect the distance of the pinch and rub operation (S417), and determines whether the pinch and rub operation distance is more than a predetermined threshold value L2 (L2>L1: for example, L2 can be set to be as large as several times to several tens of times of L1) or not (S418). While the distance of the pinch and rub operation does not reach the threshold value L2, as long as the pinch and rub operation continues, Steps S415-S417 will be repeated.

Since the icon is highlighted, reduced and/or deformed, the user can tell that the pinch and rub operation has been applied to the icon.

When the distance of pinch and rub operation exceeds the threshold value L2 (S417: YES) since the pinch and rub operation continues, the CPU 100 breaks off the display of the icon as shown in FIG. 7B (S419). For this action, the icon is deleted. When the icon is deleted (S419), as shown in FIG. 7G, an image notifying that the icon 521 is deleted is displayed. FIG. 7G shows an image effect as if the icon 521 exploded and vanished.

When the first input position P1 or the second input position P2 stops being detected (S416: No) before the distance of the pinch and rub operation reaches the threshold L2, that is, when the fingers are released from the display surface 11c or the input surface 16a, the CPU 100 returns the display state of icon 521 which is displayed in a processing state of reduction/change of shape (FIGS. 7C-7F) to original state (S420), and finishes the processing shown in FIG. 9.

The CPU 100 performs above highlight display by applying the image effect that changes colors of the target icon 521 and a circumference around the target icon 521. A method for highlighting the display can be any method as long as it notifies that the targeted icon 521 is a target for the user's operation, and it is fine to be highlighted with the method different from the above method.

As described above, according to the construction of the present example, when the pinch and rub operation is performed on an icon 521, the icon 521 is deleted from an application activation screen 520. A user can delete an icon 521 by performing an operation to delete the icon 521 by crumpling the icon 521 which the user wants to erase, or performing an operation to delete the icon 521 by rubbing the icon 521 to the display surface 11c and input surface 16a. That is, the user can delete the icon 521 with a simple and intuitively understandable operation.

An operation to delete (erase) a specific object displayed on the display surface 11c, such as deleting an icon, etc., is usually better to be performed carefully. Compared to slide, tap and flick operations, pinch and rub operation is hard to be falsely detected by accidental contact by an object to be contacted to the display surface 11c and input surface 16a. Thus, according to the present example, deleting the icons by mistake would be suppressed.

FIGS. 7C-7G are examples of image effects notifying a user the process of deleting the icon 521 simply. Various constructions other than the above can be used, such as, based on the pinch and rub operation, a brightness of the deletion target icon 521 can be gradually lowered, etc. Also, it can be constructed without such an image effect.

### Example 4

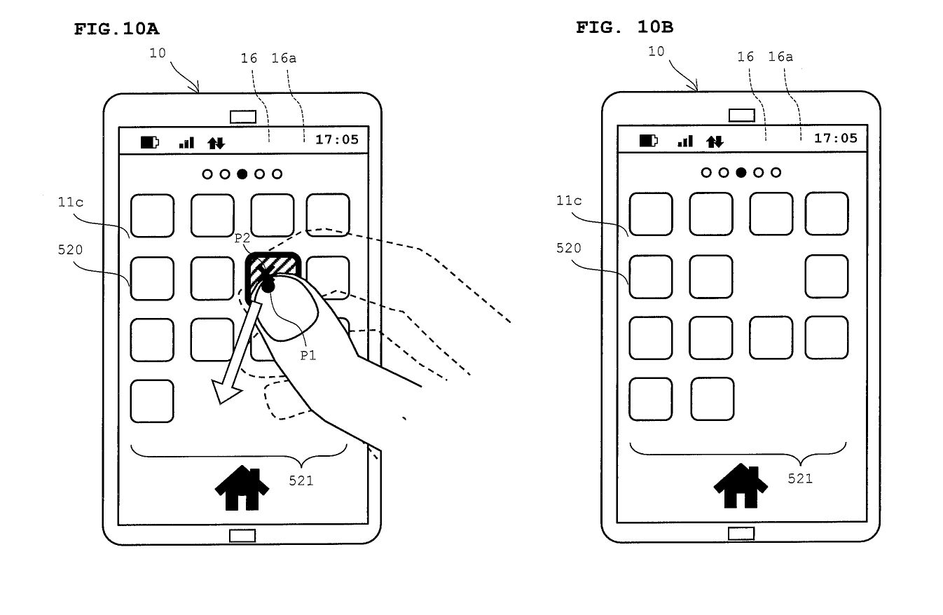

FIGS. 10A and 10B are diagrams illustrating the screen transition examples in a process being executed according to the present example.

In the example 4, based on the both faces sliding operation, an operation targeted icon is moved. The both faces sliding is an operation that the first input position P1 and the second input position P2 move in the same direction while the relative distance between the first input position P1 and the second input position P2 is kept in a state within the predetermined range (for instance, between several millimeters and a few centimeters), in a state both the display surface 11c and the input surface 16a are being touched (see FIG. 10A). The CPU 100 determines whether the performed operation is the both faces sliding operation or not based on the obtained first input position P1 and second input position P2.

FIGS. 10A and 10B are the application activation screen 520 as the same with FIG. 7A. In the present example, while the application activation screen 520 is displayed on the display surface 11c, a process is executed.

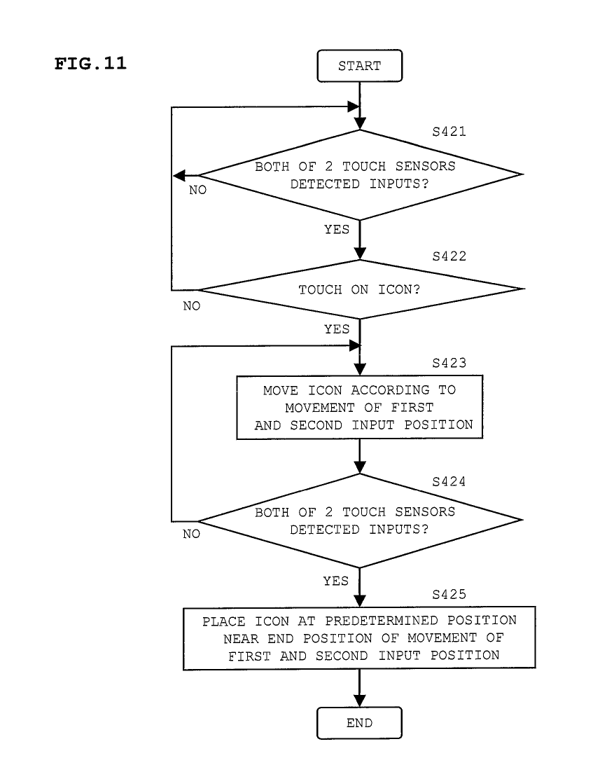

FIG. 11 is a flowchart for describing a processing procedure according to the present example.

A process of Step S421 of FIG. 11 is the same process with the Step S401 of FIG. 4. When a position corresponding to the icon 521 on the display surface 11c and the input surface 16a is touched (S422: YES), the CPU 100 executes a process to move the icon 521 (S423-S425). For example, as shown in FIG. 10A, when the position corresponding to the icon 521, line 2 from the top and the second icon from the right, on the display surface 11c and the input surface 16a is touched by fingers, the CPU 100 determines the Step S421 and S422 as YES.

After it is determined YES at the step S422, the CPU 100 moves the targeted icon 521 (S424), according to the movement of the first input position P1 and the second input position P2 based on the both faces sliding operation (see a white arrow). After that, when either of the first input position P1 or the second input position P2 would not be detected (S424: YES), the CPU 100 regards that the both faces sliding operation is finished, and as shown in FIG. 10B, the targeted icon 521 is placed at a predetermined position near the final position of the movements of the first input position P1 and the second input position P2 by the both faces sliding operation (S425).

When the targeted icon 521 is moved, the CPU 100 moves the targeted icon 521 by making it follow the moves of the first input position P1 and the second input position P2, precisely.

When the icon 521 is moved, the CPU 100 highlights the icon 521 which is the target of the operation by enlarging the size of the targeted icon 521, as shown in FIG. 10B. Because of the targeted icon 521 is highlighted, the user is notified that the icon 521 is the target of the both faces sliding operation. When the movement of the icon 521 is completed, that is, when the icon 521 is displayed at the destination (S425), highlighting of the icon 521 is cancelled and the icon 521 is displayed in a normal state.

The above highlight display can be other highlight display with other method different from the above method as long as the user is notified that the targeted icon 521 is a target of an operation. The highlight display is not limited to enlarge the sizes of the icons, but varieties of methods can be used, such as changes of brightness or saturation, or applying predetermined image effects around the target icon, etc. Besides, a construction where the targeted icon 521 is not highlighted can be selected.

According to the present example, one icon 521 is pinched with fingers and applied the both faces sliding operation, the icon 521 is moved accompanied with this both faces sliding operation. The user can move the icon 521 by an operation pinching the target icon 521 by fingers. Such operation of the movement of the icon 521 is simple and intuitive understandable.

Normally, when a mobile phone is equipped with a touch sensor on the display surface, a sliding operation to the display surface can be used for a plurality of processing. For example, a sliding operation can be used for scrolling the whole screen other than moving the icon. In this case, for instance, after a touch begins, whether the finger touched on the display screen is kept still for more than a predetermined time (for example, a few milliseconds) or not, the sliding operation would identify which one of the above two kinds of processing would correspond. In a construction which accepts a plurality of sliding operations differ from each other, false detection and false operation of the sliding operation can happen.

According to the construction of the present example, since an operation by both faces sliding is determined as an operation to move the icons, the operation for moving the icons is distinguished from other sliding operation on the display surface 11c. Thus, it can suppress false detection of the operation for moving the icon.

### Modification 1

In the example 1, 2 list images 502 and 505 are disposed on a circumference surface and end surface of the three dimensional object 501 displayed rotatably. However, contents shown by the list images can be changed suitably. In the present modification, a list image including an explanation of more detailed function compared to the list image 502 is disposed on the circumference surface of the three dimensional object 501.

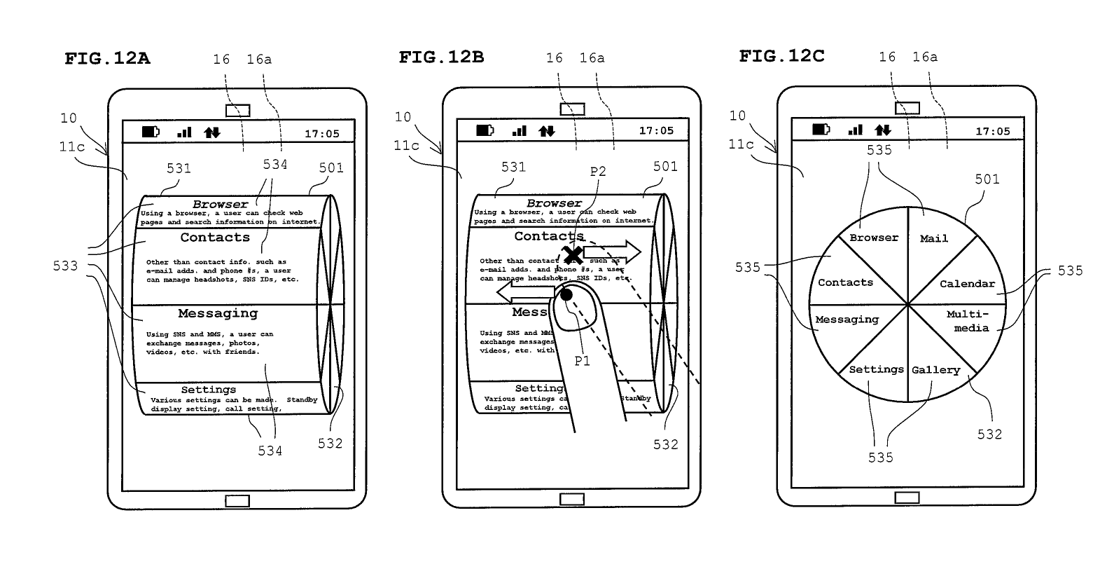

FIGS. 12A-12C are diagrams illustrating the screen transition examples in a process according to the present modification. A screen shown in FIG. 12A includes, as the same with FIG. 5A, an image of three dimensional object 501. List images 531 and 532 are displayed on a circumferential surface and end surface of the three dimensional object 501. As the same with list images 502 and 505, each area of list image 531 and each area of list image 532 correspond to each other.

As shown in FIG. 12A, in the present modification, each area of list image 531 displays text 533 showing corresponding functions and text 534 explaining the functions in details. The user can see the functions in details corresponding to the text 533 and 534 by looking at the text 533 and 534. The list image 532 are divided into 8 fan-like areas corresponding to areas in the list image 531. In each area of list image 532 includes text 535 which is the same text with the text 533 of areas corresponding in the list image 502.

Also in the present modification, as the same with the example 1, the three dimensional object 501 is rotated based on a slide or flick operation toward the display surface 11c and input surface 16a (FIG. 12B). As a result, a screen shown in FIG. 12C is displayed. Thus, the list image displayed on the display surface 11c is switched based on a simple and intuitively understandable operation.

### Modification 2

In the example 2, map image 510 is enlarged or reduced based on changes of the first input position and the second input position detected. In the present modification, based on the changes of first input position and the second input position detected, the map image 510 is enlarged, reduced and rotated.

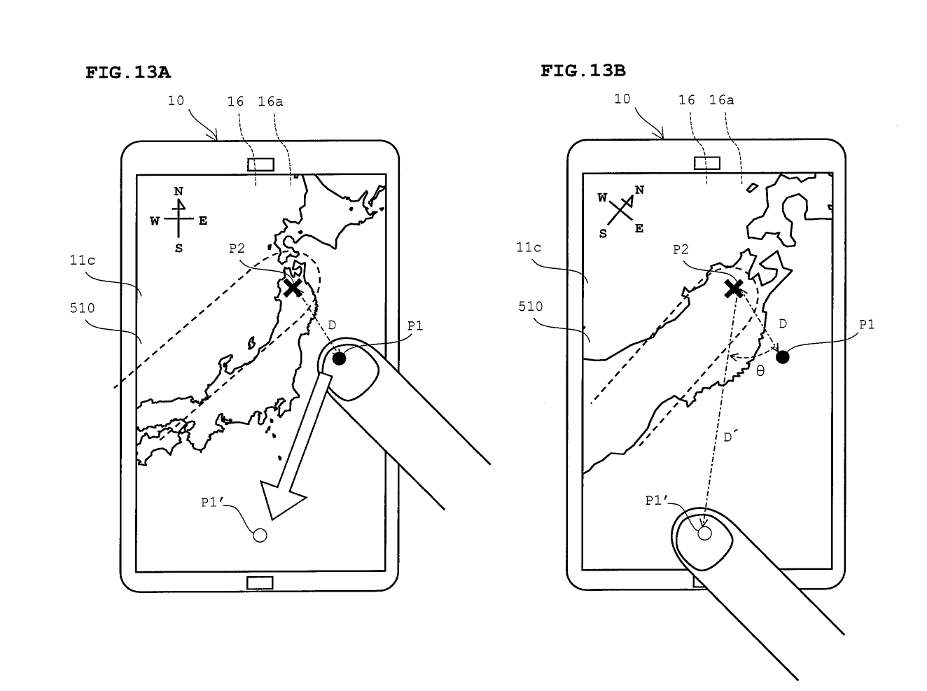

FIGS. 13A and 13B are diagrams illustrating the screen transition examples in a process according to the present modification. Processes of Steps S401 and S402 of the flowchart of FIG. 4 related to the present modification are the same processes with Steps S401 and S402 of the example 2.

In Step S403 (FIG. 4), the CPU 100 obtains a coordinate of input positions P1 (filled circle), P1′ (white circle) and P2 as the same with the embodiment 2. The CPU 100 calculates Ratio R=D′/D from distance D between P1-P2 and distance D′ between P1′-P2. Then, the CPU 100 calculates an angle θ=∠P1P2P1′ (see FIG. 13B) which is the angle between the first input position P1 and P1′ to the second input position P2 by executing a predetermined arithmetic processing. The CPU 100 rotates a map image 510 for an angle θ using the second input position P2 as a base point while enlarging or reducing the size with the ratio R using the second input position P2 as a base point (in case of FIGS. 13A and B, the image is rotated for about 40 degree clockwise).

According to the construction of the present modification, based on the detected input positions P1, P1′ and P2, the map image 510 is rotated and enlarged or reduced with the second input position P2 as of a base member. The user can set the angle θ with a simple operation by a slide. The user can enlarge or reduce the size of the map image 510 and rotate the image at the same time by a simple and intuitively understandable operation.

While the above slide operation is being done, between P1-P2 and P1′-P2, as in FIG. 13B, a supporting line (dashed line), etc., an image to notify the angle of the rotation can be displayed by overlapping on the map image 510. With such a construction, the user can recognize the angle of the rotation. To prioritize visibility of the map image 510, a construction which does not display the image to notify the angle of rotation can be selected.

### Other

The embodiment of the present invention has been described above, but the present invention is not limited to the above embodiment, and the embodiment of the present invention may be variously modified.

In the example 3, a process of Step S419 of FIG. 9 (deletion of an icon) can be suitably changed. For example, before or after deleting the targeted icon, based on the pinch and rub operation which has been done, as shown in 14A and 14B, dialogue box image (hereinafter, referred to as an “dialogue”) 541 and 542 for confirmation or notification relating to deletion of an icon may be displayed. The dialogue 541 includes button 541a which confirms the deletion of an icon and button 541b which cancels the deletion of the icon. The dialogue 542 includes a text image to notify the user that the targeted icon has been deleted. The dialogue 542 is displayed for a predetermined time after the icon has been deleted.

Determination conditions to determine whether or not the performed operation is the pinch and rub operation described in example3 can be changed suitably. For example, the CPU 100 determines an operation of both faces touch to be the pinch and rub operation when the first input position P1 and the second input position P2 is changed relatively while the relative distance between the first input position P1 and the second input position P2 is within a predetermined range (for instance, between several millimeters and a few centimeters). Here, “the first input position and the second input position are relatively changed” means that the relative positions between the first input position P1 and the second input position P2 seen from the front side of the mobile phone 1 are changed. In this case, the operation described in FIG. 8F will not be determined as pinch and rub operation. The distance of the “pinch and rub operation” in this case, for example, would be modified to an amount of change of relative positions of the first input position P1 and the second input position (a length of a trajectory of an input position of another when one input position is set to be a base point).

In addition, the CPU 100 can be constructed to determine an operation to be the pinch and rub operation when the first input position P1 and the second input position P2 meet predetermined conditions while the relative distance between the first input position P1 and the second input position P2 is within a predetermined range (for instance, between several millimeters and a few centimeters). Here, “predetermined condition” would be, for example, the first input position P1 and the second input position P2 rotate relatively in a predetermined direction, the first input position P1 or the second input position P2 repeat recurrent move to almost a definite direction, etc. Also in this case, the “distance of the pinch and rub operation” can be suitably modified according to the above predetermined conditions.

Further, the CPU 100 may be constructed to identify these plurality of pinch and rub operations suitably. For instance, referring to FIG. 7A, it may be constructed to display the deleted icon again, when an icon is deleted based on the pinch and rub operation of rotating relatively the first input position and the second input position clockwise as the above determination condition, and after the icon was deleted, a pinch and rub operation of rotating relatively the first input position and the second input position counterclockwise at almost the same position on the display surface 11c in a given time.

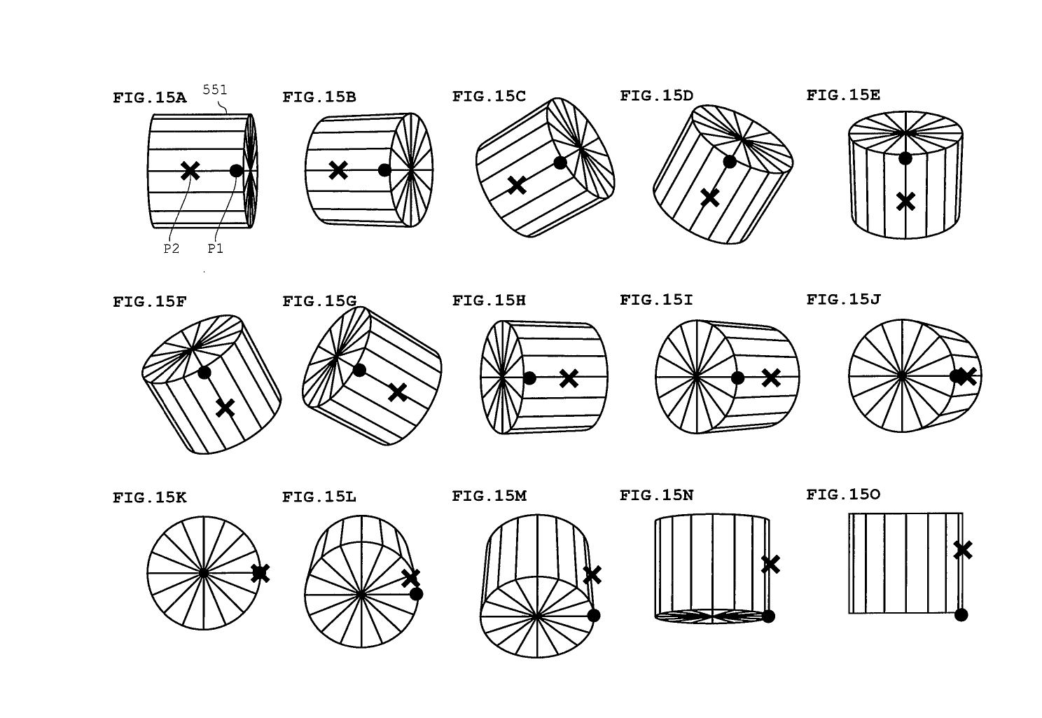

In the above example 1, the three dimensional object 501 displayed on the display surface 11c was rotated sterically in a side direction. Not limited to such a construction, but for example, as shown in FIGS. 15A-15O, the object 551 displayed on the display surface 11c can be rotated in any direction based on the operations to the display surface 11c and the input surface 16a. In FIGS. 15A-15O, a filled circle shows the first input position P1, and x-shaped sign shows the second input position P2. As illustrated above, the object 551 is rotated in the direction based on the change of detected first input position P1 and second input position P2. The user can perform the operation rotating the object 551, as if s/he pinches a real cylinder with his/her fingers and rotates the cylinder in a desired direction.

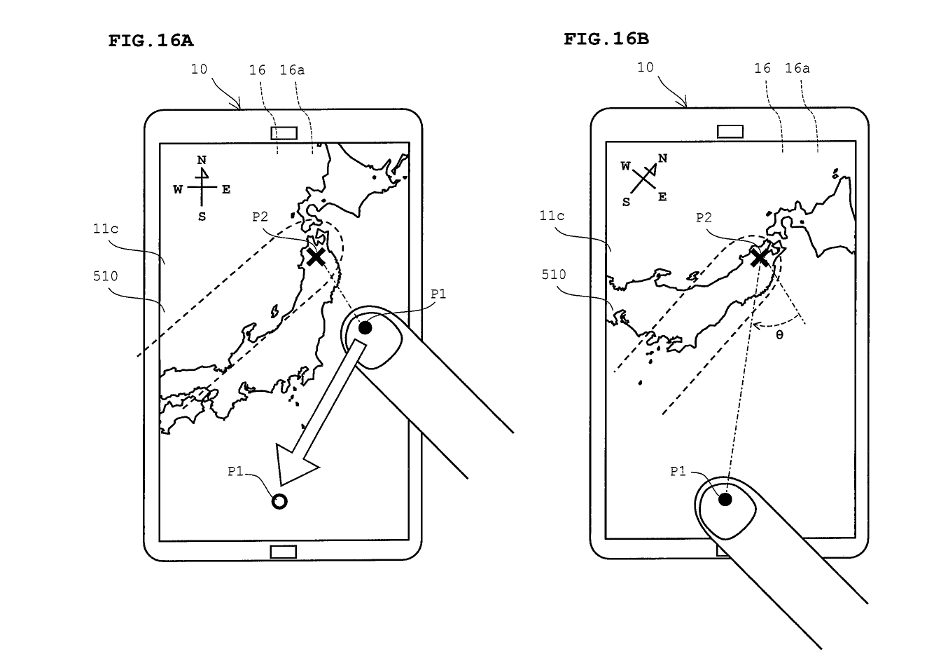

In the above example 2, map image 510 is enlarged or reduced and at the same time rotated. It is not limited with above, for instance, the map image 510 can be processed to only be rotated. In this case, for example, as in FIG. 16A, when an input is done by the same operation with FIG. 6A, the CPU 100 rotates the map image 510 at an angle θ=∠P1P2P1′ with the second input position P2 as a base point as shown in FIG. 16B.

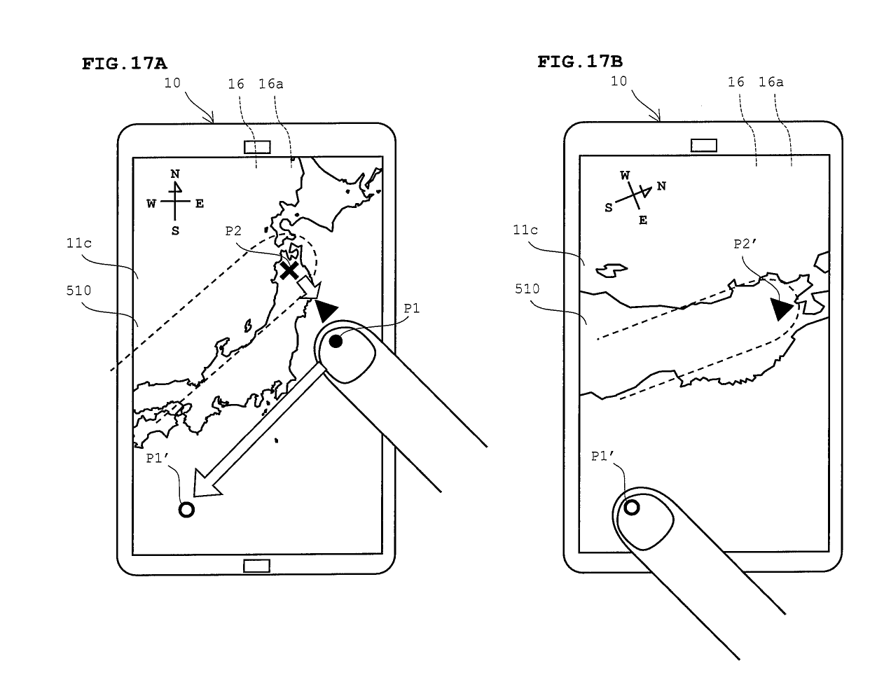

As shown in FIGS. 17A and 17B, the map image 510 can be changed according to the movements of both the first input position P1 and the second input position P2. For example, as shown in FIG. 17A, when a both faces touch operation is performed (see two white arrows), and after it is detected that the first input position travels from P1 (filled circle) to P1′ (white circle) and the second input position travels from P2 (“X” shaped sign) to P2′ (triangle sign), the CPU 100 moves, enlarges or reduces, and rotates the map image 510, following the movements of the first input position (from P1 to P1′) and the second input position (from P2 to P2′) as in FIG. 17B. That is, the CPU 100 moves the map image 510 in parallel with traveling of the second input position, and further enlarges or reduces the map image 510 by making the second input position P2′ after the move as a base point, and at the same time, the CPU 100 also rotates the map image 510 by making the second input position P2′ after the move as the base point. Here, the ratio R related to the enlargement and reduction is a ratio of a distance between the first input position and the second input position at the beginning and the end of the operation. That is, when D is the distance between P1-P2 and D′ is the distance between P1′-P2′, R=D′/D. Rotation angle θ related to the above rotation is an angle made by segment P1-P2 and segment P1′-P2′. In FIG. 17B, the position of x-shaped sign on the map image 510 shown in FIG. 17A is moved to the position of triangle sign, the map image 510 is rotated clockwise on the position of triangle sign for the rotation angle θ, and further the map image 510 is enlarged at the ratio R being centered with the position of the triangle sign.

In the above example 3, based on the pinch and rub operation, the icon is deleted. However, a target to be deleted can be an object other than the icons. For example, when the pinch and rub operation is done on an image (object) for creating and editing an electronic document, etc., the image in the middle of creating or editing the electronic document may be deleted.

In this case, a process to delete the image of the object can be executed based on the process as the same with FIG. 9. However, “icons” in Steps S412, S415, S419 and S420 of FIG. 9 can be replaced with the “object” that is the target to be deleted. A processing of Step S415 for displaying image effect depicting a process of deleting the object can be changed according to usage environment of data and application related to the object, etc.

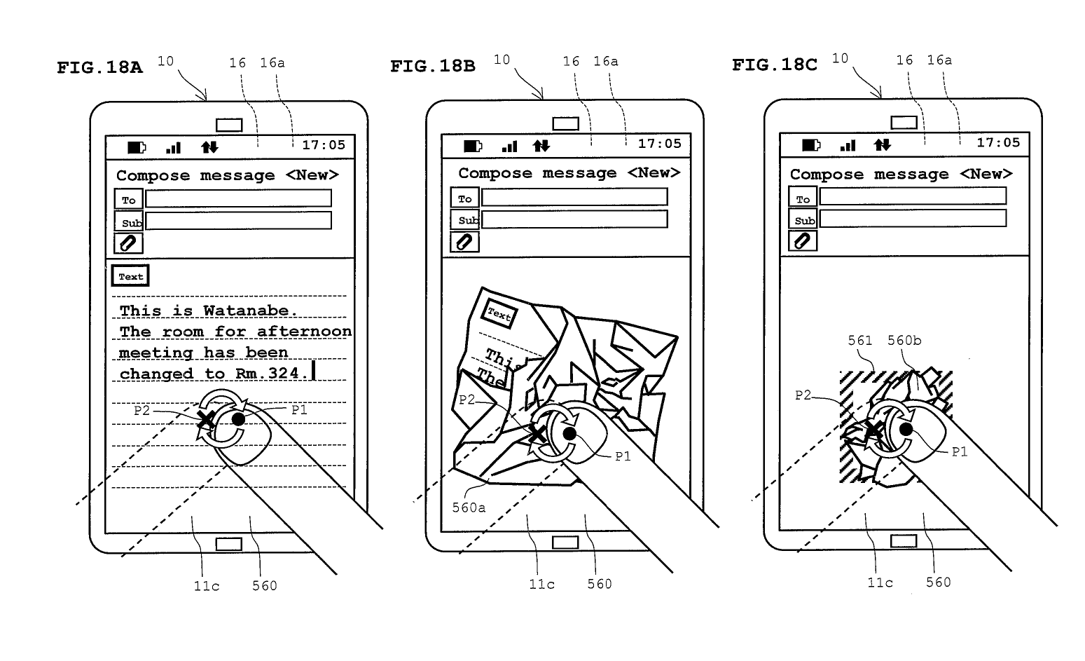

For example, as shown in FIGS. 18A-18C, when the pinch and rub operation is performed on the text image of an electronic mail that is being created, a processing that is the text image 560 of the electronic mail being deleted gradually by an image effect as if a paper is crumpled with fingers (see image 560a and 560b) is executed. When the pinch and rub operation is done for more than a predetermined distance, the CPU 100 displays image 561 which notifies that the data can be destroyed as in FIG. 18C. After that, when the fingers are released, the CPU 100 deletes the image of the mail text in the middle of being created, and at the same time, destroys the data of the mail text being created.

In the process of FIG. 9, based on the distance of the pinch and rub operation (S414 and S418), predetermined objects (icons, e-mail text, etc.) are deleted. However, it is not limited to the distance of the pinch and rub operation, for example, it can be constructed to delete the predetermined object based on the time continued to be performed the pinch and rub operation.

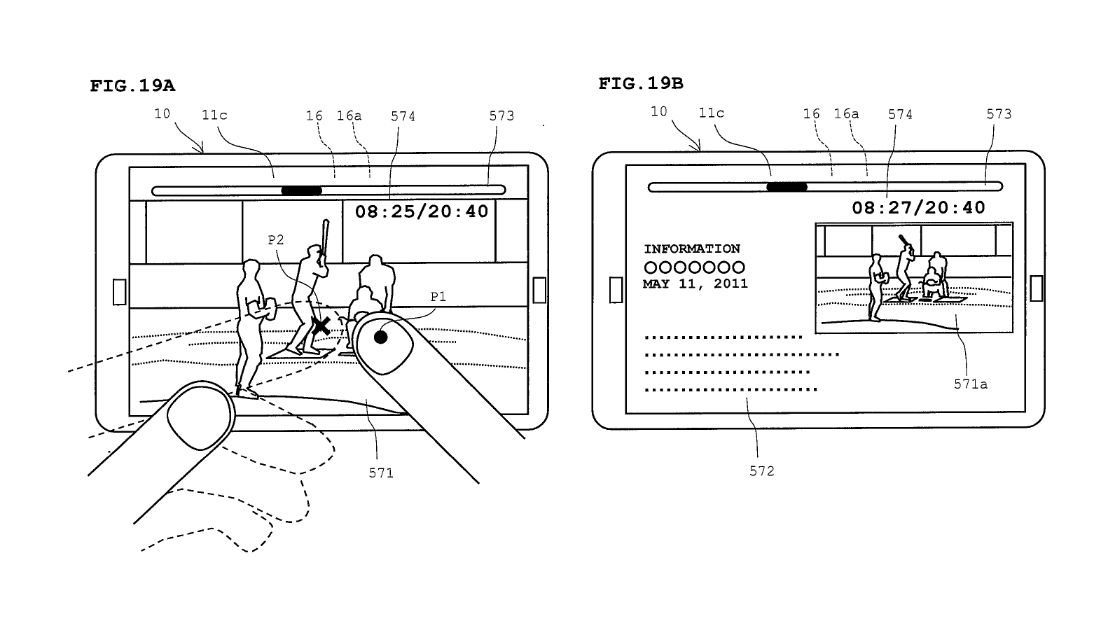

In the above examples 1-4, based on a combination of the first input position P1 and the second input position P2, the screen displayed on the display surface 11c is changed. However, it can be constructed that the screen changes based on the presence and the absence of inputs to the display surface 11c and the input surface 16a, that is not based on the positions of the inputs. For instance, as shown in FIG. 19A, during a reproduction of predetermined moving image 571, based on being tapped at almost the same time on any positions in display surface 11c and input surface 16a (S402: YES), the CPU 100 displays a screen on the display surface 11c as shown in FIG. 19B, without stopping the reproduction. On the display surface 11c shown in FIG. 19B, a moving image 571a which is a reduced sided moving image of the reproduced moving image 571 and an image of text 572 which explains the information related to the moving image 571 being reproduced are displayed (S403).

The operations of the both faces touch described in the above examples 1-4 are just examples, so the screen displayed on the display surface 11c can be changed based on the both faces touch by other forms.

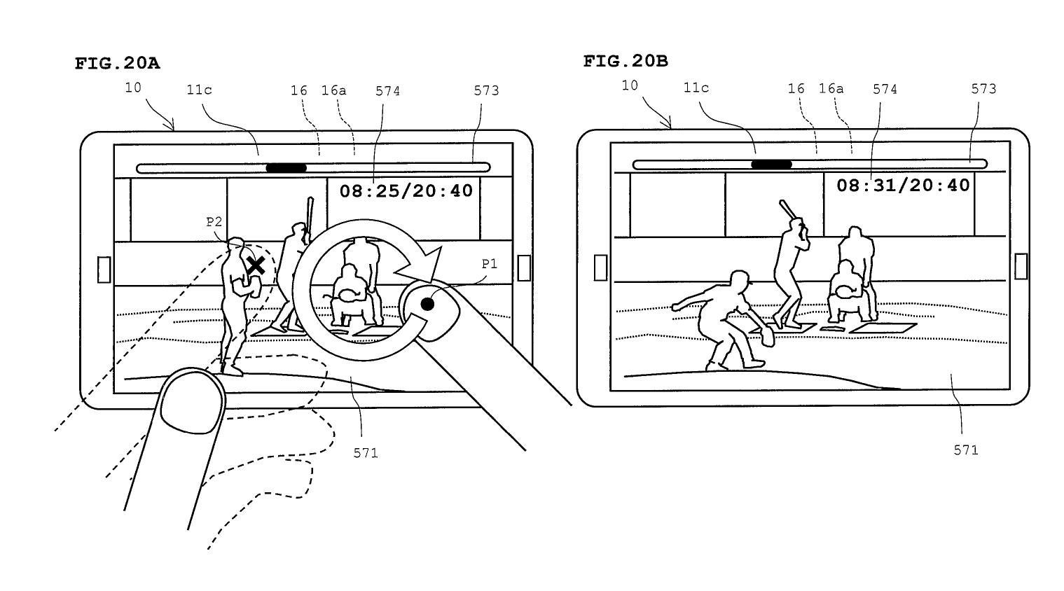

For example, it may be constructed to perform frame-by-frame advance of a currently reproduced moving image (S403) as if turning the hands of a clock and advancing the time based on the number of times a circle was drawn or the angle of the circle when a position of the input surface 16a is touched and an operation of sliding as if drawing a circle on the display surface 11c is done (S402: YES) while the moving image 571 is reproduced as shown in FIG. 20A. For example, it can be constructed that one clockwise circle of the sliding operation shown in FIG. 20A corresponds to the frame-by-frame advance of one second. In this case, the CPU 100 advances the moving image 571 frame-by-frame according to the change of the first input position P1 by the sliding operation. For instance, as shown in FIG. 20A, when a sliding operation of 6 and half laps are performed clockwise, the CPU 100 advances the display of the progress bar 573 and reproduction time display section 574 for 6 seconds, and displays the moving image 571 of the moment in 6.5 seconds. When the sliding operation of counterclockwise is performed, the CPU 100 similarly executes a frame-by-frame viewing (backwards) as one lap equals one second.

Generally, a mobile phone without an input surface 16a can specify the reproduction time by operating a progress bar displayed on a display during the reproduction of a moving image. However, an operation toward the progress bar might have problem specifying the time finely (for example, by time unit less than 1 second). In contrast, an operation of FIG. 20 can specify the reproduction time back and forth more finely than the operation to the progress bar displayed on the display.

The operation specifies the reproducing time back and forth finely is not necessarily limited to the operation displayed in FIG. 20A. For example, it can be constructed to perform the frame-by-frame advance of the currently reproduced moving image when a position on the input surface 16a is touched, and a slide operation to a left and right directions is performed on the display surface 11c. In this case, the CPU 100 reproduces the currently reproducing moving image frame-by-frame forward or reverse according to the moving distance of the first input position P1 in the right direction or the left direction (for example, movement of a few centimeters correspond to a frame advance or reverse for a second).

It can be constructed to be acceptable of a plurality of operations by inputs to the display surface 11c and the input surface 16a as explained in the above examples 1-4. For example, it can be constructed for both an operation to delete an icon described in the example 3 (FIG. 7) and an operation to move an icon described in the example 4 (FIG. 10) can be accepted and identified to each other in a state that an application activation screen is displayed on the display surface 11c.

Further, in the above embodiments, the present invention is applied to so-called straight-style mobile phones (including smart phones). However, it is not limited to the straight-style, but also the present invention may be applied to so-called folding type mobile phones, sliding style mobile phones, and other mobile phone types.

Further, the present invention can be applied to not only the mobile phones, but also a PDA (Personal Digital Assistant), a Tablet PC, an e-book, etc. and other mobile terminal devices.

The present invention is applicable to a mobile terminal device equipped with so-called transparent display which is transparent from the front side to the back side. In this case, touch sensors are provided on the display surface and the back side surface.

The embodiment of the present invention may be modified variously and suitably within the scope of the technical idea described in claims.

What is claimed is:

1. A mobile terminal device, comprising:
a display section having a display surface;
a first detecting section which detects a touch input to the display surface;
a second detecting section which detects a touch input to a surface facing a back side of the display surface; and
a screen controlling section which executes a control to change a screen displayed on the display section based on a combination of the touch input detected by the first detecting section and the touch input detected by the second detecting section.

2. The mobile terminal device according to claim 1, wherein the first detecting section detects a position of the touch input to the display surface, and
the second detecting section detects a position of the touch input to the surface facing the back side of the display surface; and
the screen controlling section executes a control to change the screen displayed on the display surface based on a combination of a first input position detected by the first detecting section and a second input position detected by the second detecting section.

3. The mobile terminal device according to claim 2, wherein the screen controlling section executes the control including at least one of an enlargement, reduction, movement or rotation to at least apart of the screen based on the change of a relationship between the first input position and the second input position.

4. The mobile terminal device according to claim 2, wherein the display controlling section executes the control moving an icon according to movements of the first input position and the second input position when the first detecting section and the second detecting section detect the touch input at a position corresponding to an area where the icon included in the screen is displayed.

5. The mobile terminal device according to claim 2, wherein the display controlling section executes the control to change the screen to delete an object displayed on the first input position when at least the first input position or the second input position is changed while a relative distance between the first input position and the second input position is within the predetermined range.

6. The mobile terminal device according to claim 5, wherein the display controlling section executes the control to delete the icon based on detecting the touch input at the position corresponding to the area where the icon included in the screen is displayed by the first detecting section and the second detecting section, and determining the first input position or the second input position is changed on the area.

7. A storage medium retaining a computer program which provides a computer of a mobile terminal device comprising a display section having a display surface, a first detecting section which detects a touch input to the display surface, and a second detecting section which detects a touch input to the surface facing a back side of the display surface, with a function to change a screen displayed on the display section based on a combination of the touch input detected by the first detecting section and the touch input detected by the second detecting section.

8. A method of a display control of a mobile terminal device comprising a display section having a display surface, a first detecting section which detects a touch input to the display surface, and a second detecting section which detects a touch input to a surface facing a back side of the display surface, the method including steps of:
determining the touch inputs to the display surface and the surface facing a back side of the display surface based on outputs of the first detecting section and the second detecting section; and
changing a screen displayed on the display section, based on a combination of the touch input to the display surface and the touch input to the surface facing a back side of the display surface.
